(19) United States
(12) Patent Application Publication
(10) Pub. No.: US 2008/0100910 A1
(43) Pub. Date: May 1, 2008

(54) Lens having IR cut-off filter, manufacturing method thereof, and camera module using the same

(75) Inventors: Jong Hyouk Kim, Anyang (KR); Jae Ho Yu, Hwaseong (KR); Min Shick Kim, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/976,210

(22) Filed: Oct. 22, 2007

(30) Foreign Application Priority Data
Oct. 31, 2006 (KR) 10-2006-0106467

(51) Int. Cl. G02B 13/14; B05D 5/06

(52) U.S. Cl. 359/356; 348/342; 427/160; 348/E05.028

(57) ABSTRACT

Provided is a camera module having a lens with a plurality of IR cut-off filters. The IR cut-off filters are vacuum deposited in a thin film type on surfaces of two aspherical plastic lenses among a plurality of aspherical plastic lenses mounted within the camera module. The height of the camera module can be minimized and the manufacturing cost can be saved because the number of processes is reduced by the reduced number of parts.

### CROSS-REFERENCE TO RELATED APPLICATIONS

This application claims the benefit of Korean Patent Application No. 10-2006-0106467 filed with the Korea Industrial Property Office on Oct. 31, 2006, the disclosure of which is incorporated herein by reference.

### BACKGROUND OF THE INVENTION

1. Field of the Invention

The present invention relates to a camera module having a lens where infrared (IR) cut-off filters are coated in a thin film type. The IR cut-off filters are vacuum deposited in a thin film type on surfaces of two aspherical plastic lenses among a plurality of aspherical plastic lenses mounted within the camera module. Thus, the height of the camera module can be minimized and the manufacturing cost can be saved because the number of processes is reduced by the reduced number of parts.

2. Description of the Related Art

With recent technical developments, portable terminals such as mobile phone and personal digital assistant (PDA) are used as multi convergence in music, movie, TV, and game as well as phone call function. One typical technology for the multi convergence is a camera module. A resolution of the camera module is changing from 300,000 pixels (VGA) to more than 8,000,000 pixels. Simultaneously, a variety of functions such as auto focusing (AF) and optical zoom are realized.

Generally, a compact camera module (CCM) is small-sized and used in mobile communication terminals (e.g., camera phone, PDA, smart phone, etc.) and various IT devices (e.g., toy camera, etc.). Recently, the fabrication of mobile terminals with a built-in compact camera module is gradually increasing according to various tastes of consumers.

As a main component of the camera module, a charge coupled device (CCD) image sensor or a complementary metal oxide semiconductor (CMOS) image sensor is used. The image sensor concentrates an image of an object and stores its data in a memory. The stored data is displayed as an image through a display media, e.g., a liquid crystal display (LCD) or a PC monitor.

The camera module is manufactured in chip on board (COB) type, chip on flexible (COF) type, etc. The COF type camera module will be described briefly.

FIG. 1 is a cross-sectional view of a conventional COF type camera module, FIG. 2 is an exploded perspective view of a substrate attached to the conventional COF type camera module, and FIG. 3 is a graph illustrating a transmittance of an IR filter applied to the conventional camera module.

Referring to FIGS. 1 to 3, the camera module 1 includes a CCD or CMOS image sensor 2 mounted on a substrate 7 through a flip chip bonding method. The substrate 7 is coupled to the bottom of a plastic housing 3. A lens barrel 6 having a downwardly-extending cylindrical body 5 is coupled to a barrel 4 extending upward from the housing 3.

In the camera module 1, the housing 3 and the lens barrel 6 are coupled together by a female screw formed on a inner surface of the barrel 4 and a male screw formed on an outer surface of the cylindrical body 5.

An IR cut-off filter (hereinafter, referred to as an IR filter) is coupled between a lens L mounted on the top surface of the substrate 7 (i.e., the bottom of the lens barrel 6) and the image sensor 2 attached to the bottom of the PCB 7. In this way, IR rays with excessively long wavelength are prevented from flowing into the image sensor 2.

In such an assembled camera module, while light flowing from a specific object passes through the lens L, the image of the object is inverted, and the light is focused on the surface of the image sensor 2. At this time, while the lens barrel 6 screwed to the upper portion of the housing 3 is rotated, an adhesive is injected into a gap between the housing 3 and the lens barrel 6 at a location where an optimal focus is adjusted. In this way, the housing 3 and the lens barrel 6 are bonded together in the focused state, thereby producing final camera module products.

The multi-layer lens L within the lens barrel 6 functions to project an image on the image sensor 2, and the image sensor 2 functions to receive light form the lens L to reproduce colors of the image.

The image sensor 2 reproduces colors by combining three kinds of colors using red, green and blue color filters. In the case of the red color, since light having a wavelength longer than that recognized by human is recognized through a sensor, a color different from that recognized by human is reproduced. Therefore, an IR filter must be used for removing optical noise from incident light in order to reproduce the same color as that recognized by human.

That is, the IR filter removes near infrared wavelengths from light incident through a plurality of lens groups. The CCD or CMOS image sensor can detect an infrared light of 1150 nm as well as a visible light of 400-700 nm, which can be seen by human's eyes, when converting an electric signal into a light signal. Thus, signals having no relation to actual colors or images saturate the detector. For this reason, two materials (TiO2/SiO2 or Ta2O5/SiO2) having different refractive index are alternately deposited on a glass substrate up to 30 to 40 layers in order to remove near infrared wavelengths. In this way, the optical filter is formed to transmit the visible light and reflect the near infrared light of greater than 650 nm, as illustrated in FIG. 4.

In manufacturing the COF, COB or CSP type camera module according to the locations of the image sensor, an adhering process using an ultraviolet (UV) curing adhesive is commonly performed to fix the transparent-glass-type IR filter on the optical path through which light is introduced into the light receiving part of the image sensor. Therefore, the IR light having a long wavelength is blocked and external moisture is prevented from penetrating into the sensing surface of the image sensor.

Meanwhile, as resolution and pixel number desired by consumers are increasing, the camera module mounted on the mobile communication terminals such as hand-held terminals become miniaturized. As one example, the camera module is designed in such a manner that a space is reduced by a thickness of the IR filter by forming an IR filter coating layer on the glass 8 mounted within the housing or forming an IR coating layer on surfaces of a plurality of glass lens mounted within the lens barrel.

However, in the case of mounting the glass where the IR coating layer is formed or using the glass lens L where the IR coating layer is formed, a glass or plastic glass must be separately mounted on the substrate where the image sensor is attached. Hence, there is a limitation in reducing the size of the camera module, that is, the height from the substrate to the top of the lens barrel 6.

Further, since the glass equal to or smaller than the substrate 7 must be always mounted, an additional cost is incurred from the use of the glass and the process of attaching the glass where the IR coating layer is formed must be further performed. This leads to increase in the manufacturing cost of the camera module.

Furthermore, the IR coating layer for cutting off the IR light is formed at a high temperature so as to alternately stack two different materials up to 30 to 40 thin films. Therefore, if the glass lens L is replaced with a plastic lens, the aspherical plastic lens is molten due to high heat generated when the IR coating layer is formed, thus damaging its surface.

In order to solve the problem that melts and damages the aspherical plastic lens, a thin film is deposited on the aspherical plastic lens using low-temperature plasma. However, the low-temperature plasma deposition process is difficult to carry out and a temperature-temperature plasma deposition apparatus is expensive, increasing the manufacturing cost of the camera module.

### SUMMARY OF THE INVENTION

An advantage of the present invention is that it provides a lens having an IR filter. Specifically, a plurality of aspherical plastic lenses are stacked within a lens barrel of a camera module, and IR cut-off thin films are deposited on surfaces of two aspherical plastic lenses so as to cut off IR light. Therefore, glass-type IR filters are removed within the camera module, thereby minimizing the height of the camera module.

Another advantage of the present invention is that it provides a camera module that can reduce the number of parts because two lenses are integrally formed with IR filters on their surfaces. Furthermore, a process of attaching the IR filter is omitted in the manufacture of the camera module, thereby reducing the manufacturing cost of module products.

Additional aspects and advantages of the present general inventive concept will be set forth in part in the description which follows and, in part, will be obvious from the description, or may be learned by practice of the general inventive concept.

According to an aspect of the invention, a camera module include: a lens having an IR filter thereon; a lens barrel in which a plurality of plastic lenses are sequentially stacked, the plastic lenses including at least two lens having the IR filter; a housing connected to the lens barrel vertically with respect to an optical axis; and a printed circuit board (PCB) closely attached to the bottom of the housing, an image sensor being mounted on the center portion of the PCB.

A multi-layer thin IR filter may be formed on lens surfaces of at least two aspherical plastic lenses by a vacuum deposition process.

The IR filter may include a plurality of IR cut-off layers on curved surfaces of a region having a largest curvature among surfaces of the aspherical lens. The IR filters may include 10-15 IR cut-off layers stacked on each of the plastic lenses.

The vacuum deposition process may include a resistor heating deposition process, an E-beam evaporation process, an ion-beam deposition process, a laser deposition process, and an RF induction heating deposition process.

IR light of a long wavelength among incident light concentrated on an image sensor within a camera module may be cut off by multi-layer thin IR filters deposited on surfaces of two lenses, while passing through a plurality of lenses stacked within the lens barrel. Therefore, the camera module is assembled with the exception of separate IR filters, thereby achieving ultra-thin camera modules. Furthermore, a gap between the image sensor and the IR filter may be wide because the IR filters are deposited on the surfaces of two lenses, thereby preventing defects caused by foreign particles.

Moreover, since the multi-layer filters are deposited on the surfaces of two aspherical plastic lenses by a vacuum deposition process, thin films of the IR filters may be densely grown within a temperature range at which crystal structure of a polymer-based plastic lens is not influenced.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of a conventional COF type camera module;

FIG. 2 is an exploded perspective view of a substrate attached to a conventional COF type camera module;

FIG. 3 is a graph illustrating a transmittance of an IR filter applied to a conventional camera module;

FIG. 4 is a cross-sectional view of a camera module with a lens having an IR cut-off filter according to an embodiment of the present invention;

FIG. 5 is a graph illustrating a transmittance of a first IR cut-off filter according to an embodiment of the present invention;

FIG. 6 is a graph illustrating a transmittance of a second IR cut-off filter according to an embodiment of the present invention; and

FIG. 7 is a graph illustrating an IR transmittance of an incident light, which simultaneously passes through the first and second IR cut-off filter, according to an embodiment of the present invention.

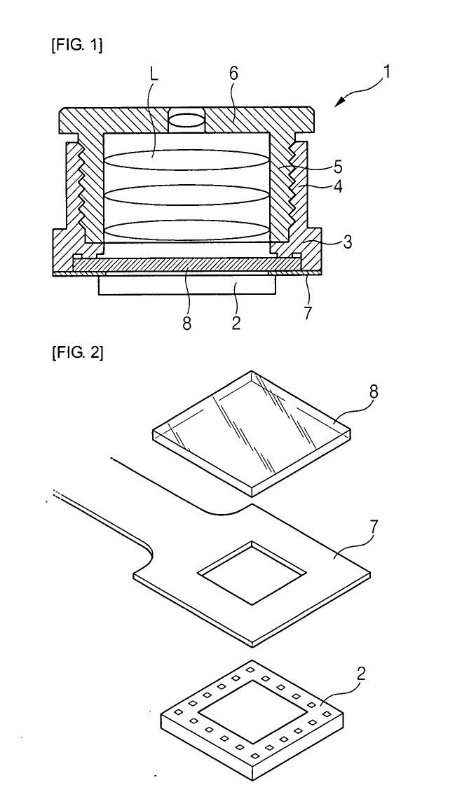

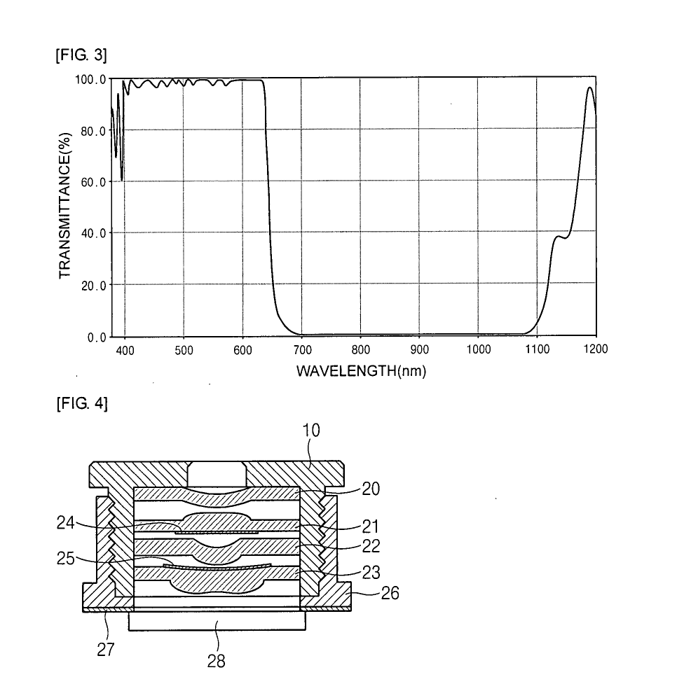

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures. In the drawings, the thicknesses of layers and regions are exaggerated for clarity.

FIG. 4 is a cross-sectional view of a camera module with a lens having an IR cut-off filter according to an embodiment of the present invention.

Referring to FIG. 4, at least two aspherical lenses 20 to 23 are sequentially stacked within a lens barrel 10. A first IR cut-off filter 24 is formed on one surface of the aspherical lens 21, and a second IR cut-off filter 25 is formed on one surface of the aspherical lens 23. The first and second IR cut-off filters 24 and 25 are stacked in a multiple thin film type.

The aspherical lenses 20 to 23 stacked within the lens barrel 10 may include aspherical plastic lenses that are injection molded of polymer, or may include a combination of aspherical plastic lenses and glass lenses. The first and second IR cut-off filters 24 and 25 are deposited on surfaces of at least two of the aspherical plastic lenses 20 to 23.

The first and second IR cut-off filters 24 and 25 are deposited on surfaces of the aspherical plastic lenses 20 to 23 by a vacuum deposition process. The vacuum deposition process for the first and second IR cut-off filters 24 and 25 may be performed at 130° C., which is below a transition point of the aspherical plastic lenses 20 to 23.

In order for dense thin film growth of the first and second IR cut-off filters 24 and 25 while maintaining the temperature of the thin film forming surfaces of the aspherical plastic lenses 20 to 23 below the transition point, it is preferable that the temperature condition is below 130° C., which is below the transition point of the aspherical plastic lenses 20 to 23.

The conditions and processes of forming the thin IR cut-off filters 24 and 25 on the surfaces of the aspherical plastic lenses 21 and 23 will be described below in detail.

The first and second IR cut-off filters 24 and 25 include 10- to 15-layer IR cut-off filters in which a low refractive layer and a high refractive layer have a thickness of approximately 1-1.5 μm.

Adhesion between the first and second IR cut-off filters 24 and 25 and the aspherical plastic lenses 21 and 23 may be weakened by the thin films naturally formed on both sides of the aspherical plastic lenses 21 and 23. To minimize the weakening of the adhesion, the aspherical plastic lenses 21 and 23 are placed inside a chamber (not shown) and impact is applied to the surfaces of the aspherical plastic lenses 21 and 23 by using ion beams to remove thin films previously formed thereon.

In removing the thin films previously formed on the surfaces of the aspherical plastic lenses 21 and 23 by using the ion beams, an ion gun whose direction control is easy is used to make the ion beams collide against the thin films grown on the surfaces of the aspherical plastic lenses 21 and 23. In this way, the thin films are removed from the surfaces of the aspherical plastic lenses 21 and 23 by the ion beams having constant energy and current density.

Since the surfaces of the aspherical plastic lenses 21 and 23 can be kept clean, the adhesion between the surfaces of the aspherical plastic lenses 21 and 23 and the multi-layer IR cut-off filters 24 and 25 can be increased. Thus, the multi-layer IR cut-off filters 24 and 25 can be more firmly deposited on the surfaces of the aspherical plastic lenses 21 and 23.

After removing the thin films previously formed on the surfaces of the aspherical plastic lenses 21 and 23, IR cut-off filters are deposited on the surfaces of the aspherical plastic lenses 21 and 23. At this point, the IR cut-off filters are deposited while a high refractive component and a low refractive component are alternately stacked. Examples of the high refractive material include TiO₂, TaO₂, ZrO₂, and Ta₂O₅, and examples of the low refractive material include SiO₂ and Al₂O₃.

In alternately depositing the high refractive layer and the low refractive layer, a vacuum deposition process is used to evaporate a deposition material by heating it within a chamber. The IR cut-off filters are deposited in a 10- to 15-layer structure on the surfaces of the aspherical plastic lenses 21 and 23 placed inside the chamber. In this way, the first and second IR cut-off filters 24 and 25 are formed.

The reason why the first and second IR cut-off filters 24 and 25 are deposited to the 10- to 15-layer structure is as follows. An internal temperature of the chamber rises higher than the transition point of the aspherical plastic lenses 21 and 23 due to a long time deposition process when a 30- to 40-layer IR cut-off filter is deposited by a vacuum deposition process. Thus, the aspherical plastic lenses 21 and 23 are molten due to the high temperature of the chamber above the transition point. Consequently, the aspherical plastic lenses 21 and 23 are deformed.

By depositing the first and second IR cut-off filters 24 and 25 in the 10- to 15-layer structure on the surfaces of the aspherical plastic lenses 21 and 23, the deposition process time is reduce more than the conventional 30- to 40-layer IR filter. Therefore, the internal temperature of the chamber can be maintained below than the transition point of the aspherical plastic lenses 21 and 23. In this way, the deposition of the first and second IR cut-off filters 24 and 25 can be completed without deformation of the aspherical plastic lenses 21 and 23.

Further, the first and second IR cut-off filters 24 and 25 must be formed such that an optical coating of a multi-layer thin film can be achieved by finding an optimal thin film coating surface on the aspherical surfaces. The optimal coating surfaces are defined as a curved surface that can cover all incident light, that is, a region having the largest curvature among the lens surfaces having an optical surface of a rotational symmetry with respect to a region where incident angle becomes minimum by a paraxial axial tracing.

Meanwhile, examples of the vacuum deposition process include a resistor heating deposition process, an E-beam evaporation process, an ion-beam deposition process, a laser deposition process, and an RF induction heating deposition process.

In the resistor heating deposition process, the E-beam heating evaporation process, the ion-beam deposition process, the laser deposition process, and the RF induction heating deposition process, a thermal source having a high melting point is used. The thermal source is formed in an appropriate shape and used as an evaporation source. A deposition material is placed and heated by applying a current to the deposition source, or evaporated by heating it using an E-beam, an ion-beam, or a laser beam. In this way, the thin films are deposited.

In forming the plurality of IR cut-off layers forming the first and second IR cut-off filters 24 and 25 on the surfaces of the aspherical plastic lenses 21 and 23 using one of the above-described vacuum deposition methods, the density of the IR cut-off layer increases when impact is applied to the thin film using the ion beam as an auxiliary means. Thus, the thin film robust against an external environment can be deposited.

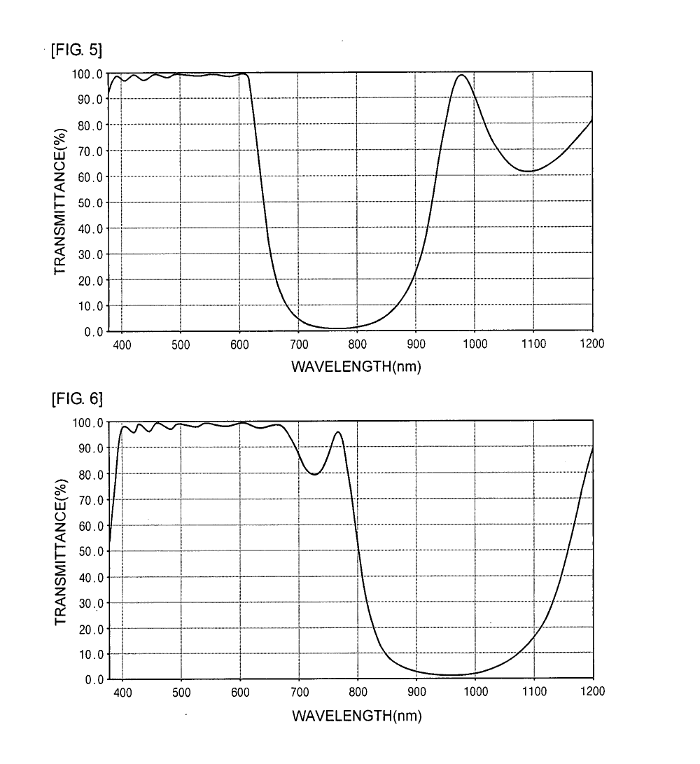

FIG. 5 is a graph illustrating a transmittance of the first IR cut-off filter according to an embodiment of the present invention. As illustrated in FIG. 5, the first IR cut-off filter 24 deposited on one surface of the aspherical plastic lens 21 exhibits a high transmittance of more than 95% at a wavelength of less than 620 nm and a wavelength of 980±10 nm, and a low transmittance at a wavelength of 620-970 nm and a wavelength of greater than 990 nm.

FIG. 6 is a graph illustrating a transmittance of the second IR cut-off filter according to an embodiment of the present invention. As illustrated in FIG. 6, the second IR cut-off filter 25 deposited on one surface of the aspherical plastic lens 23 exhibits a high transmittance of more than 95% at a wavelength of less than 680 nm and a low transmittance at a wavelength of greater than 680 nm.

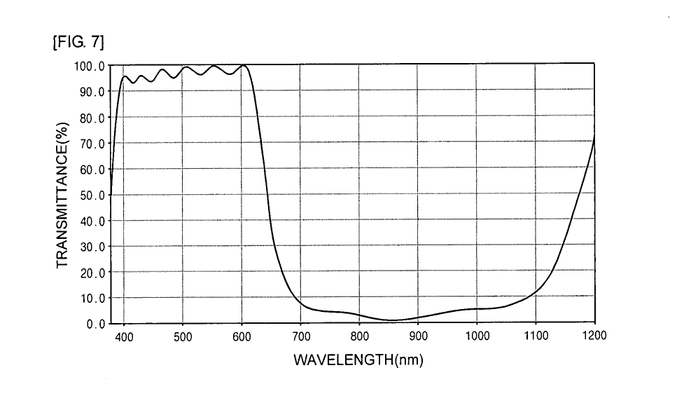

FIG. 7 is a graph illustrating an IR transmittance of an incident light, which simultaneously passes through the first and second IR cut-off filter, according to an embodiment of the present invention. As illustrated in FIG. 7, when the aspherical plastic lenses 21 and 23 are mounted within the lens barrel 10, the transmittance is greater than 95% at a wavelength of less than 620 nm and is less than 10% at a wavelength of greater than 620 nm due to the first and second IR cut-off filters 24 and 25 deposited on the surfaces of the aspherical plastic lenses 21 and 23. That is, it can be seen that the first and second IR cut-off filters 24 and 25 deposited on the surfaces of the aspherical plastic lenses 21 and 23 can effectively cut off the IR rays.

The IR cut-off efficiency of the camera module using both the first and second IR cut-off filters 24 and 25 is close to that of the camera module using the conventional IR filter.

As described above with reference to FIG. 4, the camera module having the aspherical plastic lenses 21 and 23 where the first and second IR cut-off filters 24 and 25 are formed includes the lens barrel 10, a housing 26, and a printed circuit board (PCB). The plastic lenses 20 to 23 including the aspherical plastic lenses 21 and 23 where the first and second IR cut-off filters 24 and 25 are formed are sequentially stacked in the lens barrel 10. The housing 26 is connected to the lens barrel 10. The PCB 27 is closely attached to the bottom of the housing 26. An image sensor 28 whose center portion is exposed by the housing 26 is mounted on the PCB.

In the camera module, the IR filter having been formed on the conventional PCB 27 is removed and the first and second IR cut-off filters 24 and 25 are formed on the surfaces of the aspherical plastic lenses 21 and 23. Thus, the camera module is assembled without space where the IR filter has been disposed, thereby reducing the module height.

As described above, the first and second IR cut-off filters for sequentially cutting off the IR rays within the lens barrel of the camera module are deposited on the surfaces of the aspherical plastic lenses, thereby the reducing the height of the camera module.

Further, the number of manufacturing processes is reduced because the bonding process and the adhesive curing process for fixing the separate IR filter are omitted. Thus, the module manufacturing cost can be reduced and the process defects can be significantly reduced by the reduced number of the parts.

Furthermore, because the first and second IR cut-off filters are deposited with the 10- to 15-layer thin films within a low-temperature chamber, the aspherical plastic lenses are not damaged and the heating source for increasing the temperature of the chamber is reduced, thereby saving the manufacturing cost.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A lens comprising:
infrared (IR) cut-off filters stacked on surfaces of at least two of a plurality of plastic lenses, which are injection-molded of a polymer resin and stacked within a lens barrel solely or in combination with a glass lens.

2. The lens according to claim 1,
wherein the IR cut-off filters include a plurality of IR cut-off layers stacked on a curved surface of a region having the largest curvature among surfaces of aspherical plastic lens.

3. The lens according to claim 1,
wherein the IR cut-off filters include 10-15 IR cut-off layers stacked on each of the plastic lenses.

4. The lens according to claim 1,
wherein the IR cut-off filters are stacked using a vacuum deposition process.

5. The lens according to claim 1,
wherein the vacuum deposition process includes a resistor heating deposition process, an E-beam evaporation process, an ion-beam deposition process, a laser deposition process, and an RF induction heating deposition process.

6. A method of manufacturing a lens having an IR cut-off filter, comprising:
mounting an aspherical plastic lens within a chamber;
heating and evaporating a deposition material within the chamber to deposit a thin IR cut-off layer on one surface of the plastic lens; and
repeating 10-15 times the process of depositing the IR cut-off layer to form a 10- to 15-layer IR cut-off filter.

7. The method according to claim 6, further comprising:
removing a thin film naturally formed on the surface of the lens by applying an impact on the surface of the lens using ion beams after mounting the plastic lens within the chamber.

8. The method according to claim 6,
wherein the deposition material is heated and evaporated by one of a resistor heating deposition process, an E-beam evaporation process, an ion-beam deposition process, a laser deposition process, and an RF induction heating deposition process.

9. The method according to claim 6,
wherein the forming of the IR cut-off filter includes applying an impact using ion beams on the deposited IR cut-off layer whenever the IR cut-off layer is deposited.

10. A camera module comprising:
the lens having the IR cut-off filter according to claim 1;
a lens barrel in which a plurality of plastic lenses are sequentially stacked, the plastic lenses including at least two lenses having the IR cut-off filter;
a housing connected to the lens barrel vertically with respect to an optical axis; and
a printed circuit board (PCB) closely attached to the bottom of the housing, the PCB having an image sensor mounted on the center portion thereof.
